(19) United States
(12) Patent Application Publication
(10) Pub. No.: US 2004/0086407 A1
(43) Pub. Date: May 6, 2004

(54) Scroll type of fluid machinery

(76) Inventor: Enjiu Ke, Windsor (CA)

Correspondence Address: ENJIU KE, 1545 OUELLETTE AVE #802, WINDSOR, ON, N8X 1K6, CA

(21) Appl. No.: 10/287,042

(22) Filed: Nov. 4, 2002

(51) Int. Cl. F01C 1/02; F01C 1/063; F03C 2/00

(52) U.S. Cl. 418/55.2; 418/55.3; 418/60

(57) ABSTRACT

A scroll type of fluid machinery, in which two housings are fixed to each other, two stationary scrolls are fixed to the two housings, two orbiting scrolls are assembled together with the stationary scrolls to form volume changing mechanisms, three orbiting units are located between the two orbiting scrolls and are arranged to form an anti-self-rotation mechanism for the orbiting scrolls. Each of the three orbiting units comprises a rotating member rotatably supported on the two housings and a thrust-canceling shaft rotatably supported in an eccentric through-hole in the rotating member. Each thrust-canceling shaft is fixed between the two orbiting scrolls. When any one or more of the aforementioned rotating members are driven, the two orbiting scrolls orbit with respect to the stationary scrolls to cause the fluid volumes change. The thrust forces exerted on the two orbiting scrolls cancel one another through the thrust-canceling shafts.

### BACKGROUND OF THE INVENTION

The present invention relates to a scroll type of fluid machinery, which can be used as compressors, vacuum pumps, expansionary machines, etc.

A regular scroll type of fluid machinery usually consists of a casing, a stationary scroll fixed on the aforementioned casing, a driving crankshaft rotatably supported on the aforementioned casing through bearings, and an orbiting scroll driven by the crankshaft. The orbiting scroll is constrained by an anti-self-rotating mechanism to realize an orbiting movement with respect to the stationary scroll. The volumes formed between the stationary scroll and the orbiting scroll change with the orbiting movement of the orbiting scroll, and cause the fluid in the volumes to be compressed. Thrust force generated by the fluid pressure exerts on the orbiting scroll, and pass to a thrust bearing.

In order to reduce the energy consumed by the friction force on the thrust bearing, a double orbiting scroll structure was proposed. These two orbiting scrolls are mounted back-to-back to cancel the thrust force. This structure has been described in the U.S. Pat. Nos. 801,812, 3,011,694, and 4,990,071.

There are two approaches for the driving force input in the aforementioned patents. One approach is to make the driving shaft shun the stationary scroll and to input the driving force through some driving mechanisms surrounding the periphery of the orbiting scroll. The other approach is to make the crankshaft go through the center of the stationary scroll to drive the back-to-back orbiting scrolls.

The first approach makes the size of the machine increase greatly because the driving shaft must be mounted in outer space surrounding the stationary scroll. The second approach reduces the volume compression efficiency of the fluid machinery because the driving device occupies the central portion of the orbiting scroll, which is virtually important to the compression efficiency.

Another structure used to cancel the thrust force can be found in the U.S. Pat. No. 4,515,539, 6,267,572B1, and Japanese patent 04-121,474. Two mirror-imaged orbiting scrolls are connected to the two ends of a thrust-canceling shaft, which is rotatably fitted into an eccentric through-hole in a motor shaft. To prevent the orbiting scroll from self-rotation, a mechanism is specially provided. Furthermore, the relatively weak stiffness of the orbiting scroll due to the large bending deformation of the end plate of the orbiting scroll will affect the efficiency of the compressors.

### SUMMARY OF THE INVENTION

The present invention has been embodied to improve the performance, efficiency, and reliability of the scroll type of fluid machinery. According to one aspect of the present invention, the presented scroll type of fluid machinery comprises two housings 1A and 1B, two stationary scrolls 2A and 2B, two orbiting scrolls 3A and 3B, and three orbiting units 40. The two housings 1A and 1B are connected with each other, as shown in FIG. 1. The two stationary scrolls 2A and 2B are fixed to the housings 1A and 1B. The two stationary scrolls 2A and 2B comprise their own end plates 7A and 7B and spiral wraps 9A and 9B standing on the end plates 7A and 7B, respectively. The two orbiting scrolls 3A and 3B comprise their own end plates 8A and 8B and spiral wraps 6A and 6B standing on the end plates 8A and 8B, respectively. The two orbiting scrolls 3A and 3B are assembled with the two stationary scrolls 2A and 2B, respectively. The three orbiting units 40 are located between the two orbiting scrolls 3A and 3B. Each of the three orbiting units 40 comprises a rotating member 10 rotatably supported on the two housings 1A and 1B through two bearings 11A and 11B, a thrust-canceling shaft 20 rotatably supported in an eccentric through-hole 17 in the rotating member 10 through two bearings 14A and 14B. Each thrust-canceling shaft is fixed between the two orbiting scrolls 3A and 3B. The three orbiting units 40, the two orbiting scroll 3A and 3B, and the two housings 1A and 1B compose three parallelogram linkages that form an anti-self-rotating mechanism. When one or more of the rotating members 10 are driven, the orbiting scrolls 3A and 3B orbit in same radius with respect to the stationary scrolls 2A and 2B to cause fluid volumes change. Most of the thrusting force on the two orbiting scrolls 3A and 3B generated by fluid pressure is canceled through the three thrust-canceling shafts 20, and the rest is withstood by the bearings 11A, 11B, 14A and 14B in the orbiting units 40. Due to even loading among three orbiting units 40, all three rotating members 10 are driven. It is possible to use two orbiting units. In this case, the two rotating members of the two orbiting units can be driven by two motors. Otherwise, a synchronous device, such as synchronous belt or gears, should be needed.

### BRIEF DESCRIPTION OF THE DRAWINGS

FIG. 1 is a schematic sectional view of a scroll compressor according to the first embodiment of the present invention.

FIG. 2 is a left view of the machine shown in FIG. 1, excluding the left stationary scroll 2A, the left orbiting scroll 3A, and the left housing 1A.

FIG. 3 is a schematic sectional view of its orbiting unit 40.

FIG. 4 is a schematic sectional view of a scroll expander according to the second embodiment of the present invention.

FIG. 5 is a left view of the machine shown in FIG. 4, excluding the left stationary scroll 2A and left orbiting scroll 3A.

FIG. 6 is a schematic sectional view of its orbiting unit 40.

FIG. 7 is a schematic sectional view of a scroll compressor according to the third embodiment of the present invention.

FIG. 8 is a left view of the machine shown in FIG. 7, excluding the left stationary scroll 2A and left orbiting scroll 3A.

FIG. 9 is a schematic sectional view of its orbiting unit 40.

FIG. 10 is a schematic sectional view of a scroll compressor according to the forth embodiment of the present invention.

FIG. 11 is a left view of the machine shown in FIG. 10, excluding the left stationary scroll 2A, left orbiting scroll 3A, and left housing 1A.

FIG. 12 is a schematic sectional view of its orbiting unit 40.

FIG. 13 is a schematic sectional view of a scroll compressor according to the fifth embodiment of the present invention.

FIG. 14 is a left view of the machine shown in FIG. 13, excluding the left stationary scroll 2A, left orbiting scroll 3A, and left housing 1A.

FIG. 15 is a schematic sectional view of its orbiting unit 40.

FIG. 16 is a schematic sectional view of a scroll compressor according to the sixth embodiment of the present invention.

FIG. 17 is a left view of the machine shown in FIG. 16, excluding the left stationary scroll 2A and left orbiting scroll 3A.

FIG. 18 is a schematic sectional view of its orbiting unit 40.

FIG. 19 is a schematic sectional view of its orbiting unit 140.

FIG. 20 is a schematic sectional view of a scroll compressor according to the seventh embodiment of the present invention.

FIG. 21 is a left view of the machine shown in FIG. 20, excluding the left stationary scroll 2A, left orbiting scroll 3A, and left housing 1A.

### DETAILED DESCRIPTION OF THE INVENTION

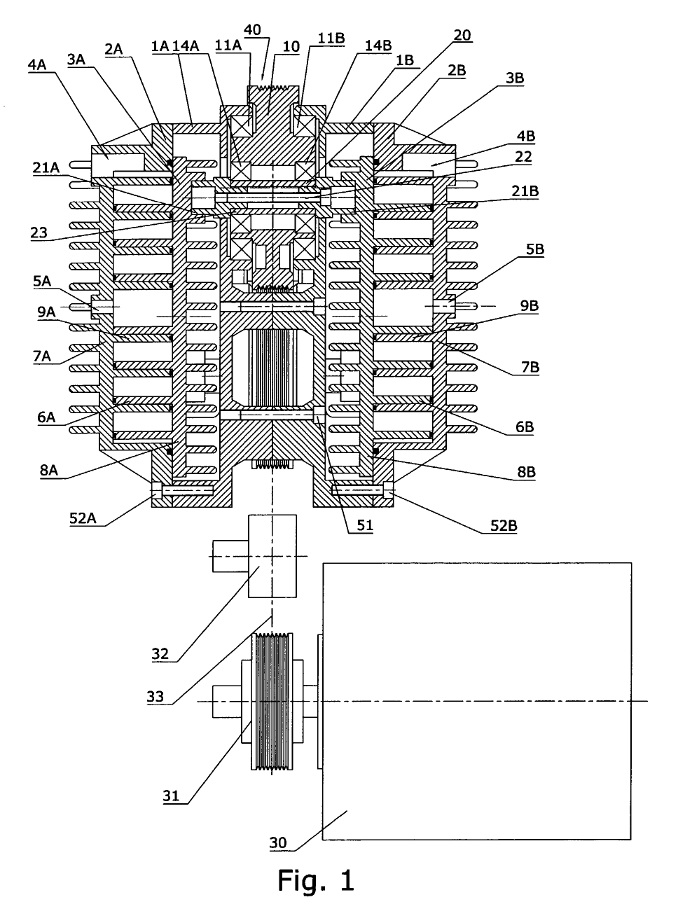

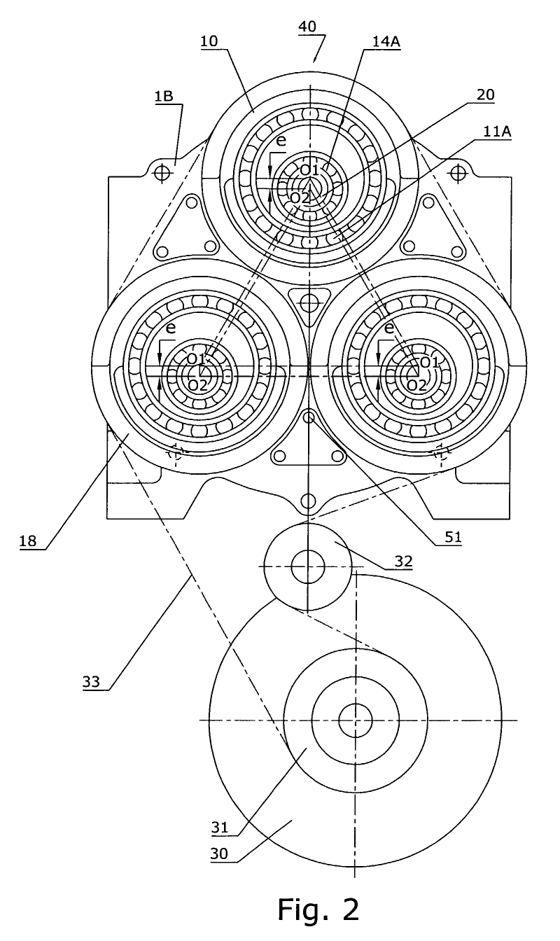

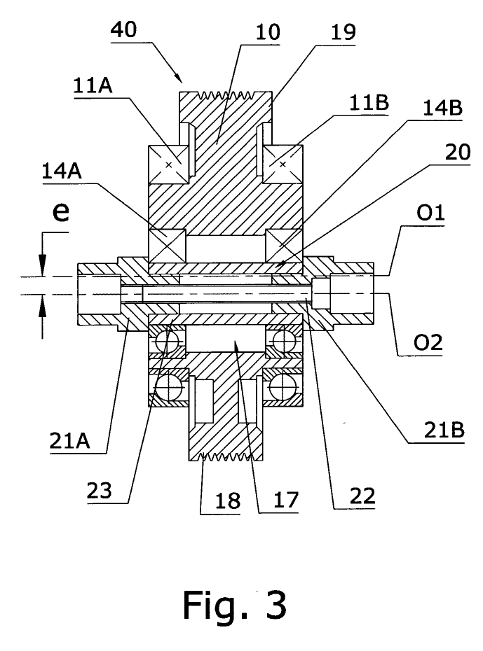

FIG. 1 is a schematic sectional view of a scroll compressor according to the first embodiment of the present invention. FIG. 2 is its left view of the compressor excluding its left stationary scroll and left orbiting scroll and left housing. FIG. 3 is a schematic sectional view of its orbiting unit. As shown in FIGS. 1-3, a left housing 1A and a right housing 1B are mounted in a mirror-image relationship through screws 51. A left stationary scroll 2A is connected to the left housing 1A through screws 52A, and a right stationary scroll 2B is connected to the right housing 1B through screws 52B. The two housings 1A and 1B, the two stationary scrolls 2A and 2B compose the fixed structure of this machine. The two stationary scrolls 2A and 2B comprise, respectively, their own end plates 7A and 7B and spiral wraps 9A and 9B standing on the corresponding end plates 7A and 7B. Two suction ports 4A and 4B should be connected, and two discharge ports 5A and 5B should be connected. The two orbiting scrolls 3A and 3B comprise, respectively, their own end plates 8A and 8B and spiral wraps 6A and 6B standing on the corresponding end plates 8A and 8B. Furthermore, the directions of the spiral wraps 6A and 6B should be arranged in a mirror-image relationship, and the directions of the spiral wraps 9A and 9B should be arranged in a mirror-image relationship. Three orbiting units 40 are mounted between the two orbiting scrolls 3A and 3B. Each of the three orbiting units 40 comprises a rotating member 10 rotatably supported on the two housings 1A and 1B through two bearings 11A and 11B, and a thrust-canceling shaft 20 rotatably supported in the rotating member 10 by two bearings 14A and 14B. The rotating member 10 comprises a balancing weight 19, a pulley 18 located on the periphery of the rotating member 10, and an eccentric through-hole 17. The rotating axis O2 of the thrust-canceling shaft 20 is eccentric from the rotating axis O1 of the rotating member 10 with a distance of e. The three thrust-canceling shafts 20 are fixed between the two orbiting scrolls 3A and 3B. As shown in FIG. 2, the triangle formed by O1-O1-O1 is identical to the triangle formed by O2-O2-O2. The three orbiting units 40, the two orbiting scroll 3A and 3B, and the two housings 1A and 1B compose three parallelogram linkages which form an anti-self-rotating mechanism. Each thrust-canceling shaft 20 comprises a left end 21A, a right end 21B, a sleeve 23, and a pre-loading screw 22. The length of the sleeve 23 should be set at such a value that the two ends 21A and 21B contact the sleeve 23 with proper pre-load. The three pulleys 18 are driven by the pulley 31 of a motor 30. A pre-tensioning pulley 32 is used to increase the wrap angles on the three pulleys 18 and the pulley 31 of the motor 30 and to apply proper pre-tension to the belt 33. The orbiting scrolls 3A and 3B get much more even driving force from the three rotating member 10, and this makes the operation of the machine smoother and more reliable. When the orbiting scrolls 3A and 3B orbit, the volumes formed by the spiral wraps 9A, 9B and 6A, 6B of the stationary scrolls 2A and 2B and the orbiting scrolls 3A and 3B are continuously changed, fluid introduced through suction ports 4A and 4B is continuously compressed, and finally the compressed fluid is discharged through the discharge ports 5A and 5B. During the process of compression, the fluid generates thrusting force exerted on the end plates 8A and 8B of the orbiting scrolls 3A and 3B. Most of the thrusting force is canceled through the three thrust-canceling shafts 20, and the rest is withstood by the bearings 11A, 11B, 14A, and 14B in the orbiting units 40. The frictional consumption of power is reduced because of the cancellation of the axial thrusting force, and this gives this machine high efficiency.

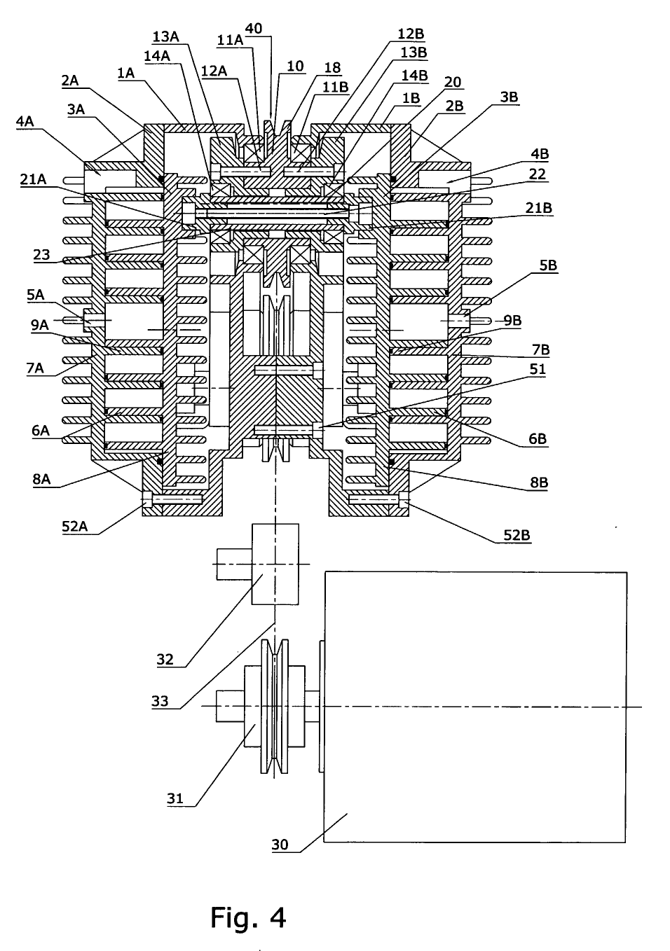

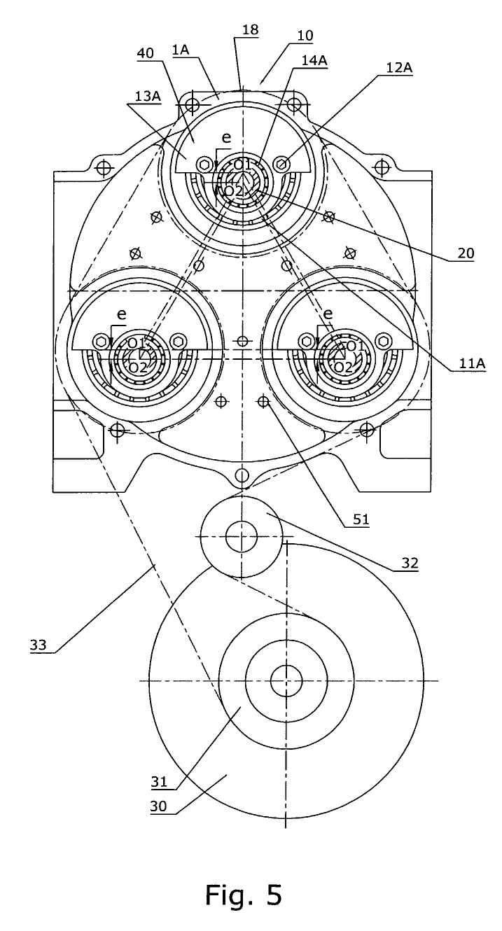

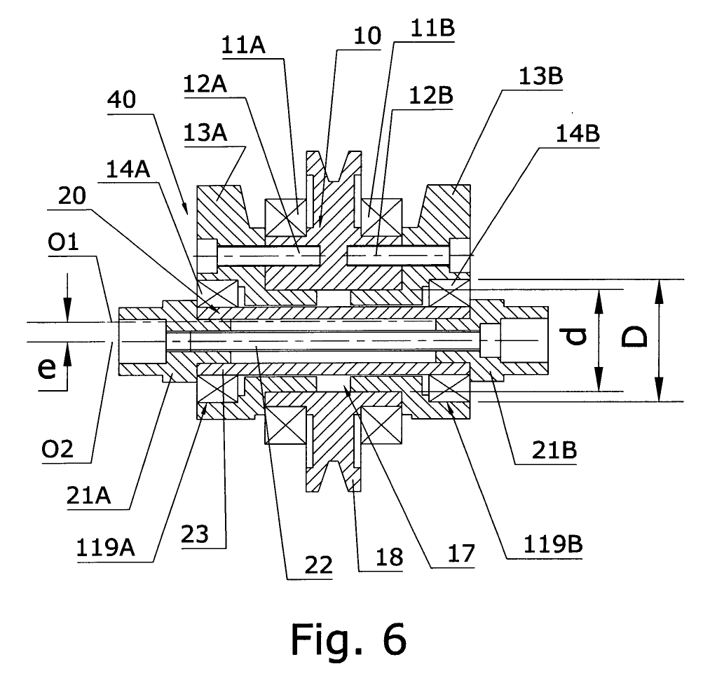

FIG. 4 is a schematic sectional view of a scroll expander according to the second embodiment of the present invention. FIG. 5 is its left view excluding its left stationary scroll and left orbiting scroll. FIG. 6 is a schematic sectional view of its orbiting unit. As shown in FIGS. 4-6, a left housing 1A and a right housing 1B are mounted in a mirror-image relationship through screws 51. A left stationary scroll 2A is connected to the left housing 1A through screws 52A, and a right stationary scroll 2B is connected to the right housing 1B through screws 52B. The two housings 1A and 1B, the two stationary scrolls 2A and 2B compose the fixed structure of this machine. The two stationary scrolls 2A and 2B comprise, respectively, their own end plates 7A and 7B and spiral wraps 9A and 9B standing on the corresponding end plates 7A and 7B. Two discharge ports 4A and 4B should be connected, and two suction ports 5A and 5B should be connected. The two orbiting scrolls 3A and 3B comprise, respectively, their own end plates 8A and 8B and spiral wraps 6A and 6B standing on the corresponding end plates 8A and 8B. Furthermore, the directions of the spiral wraps 6A and 6B should be arranged in a mirror-image relationship, and the directions of the spiral wraps 9A and 9B should be arranged in a mirror-image relationship. Three orbiting units 40 are mounted between the two orbiting scrolls 3A and 3B. Each of the three orbiting units 40 comprises a rotating member 10 rotatably supported on the two housings 1A and 11B through two bearings 11A and 11B, and a thrust-canceling shaft 20 rotatably supported in the rotating member 10 by two bearings 14A and 14B. The rotating member 10 comprises a pulley 18 with an eccentric through-hole 17 of diameter d, two balancing weights 13 A and 13B fitted in the eccentric through-hole 17 through screws 12A and 12 B, two holes 119A and 119B of diameter D being, respectively, in the two balancing weights 13 A and 13B. The bearings 14A and 14B are fitted in the holes 119A and 119B, respectively, to support the thrust-canceling shaft 20. The diameter D may be made larger than the diameter d so that larger spaces can be provided to the bearings 14A and 14B. The rotating axis O2 of the thrust-canceling shaft 20 is eccentric from the rotating axis O1 of the rotating member 10 with a distance of e. The three thrust-canceling shafts 20 are fixed between the two orbiting scrolls 3A and 3B. As shown in FIG. 5, the triangle formed by O1-O1-O1 is identical to the triangle formed by O2-O2-O2. The three orbiting units 40, the two orbiting scroll 3A and 3B, and the two housings 1A and 1B compose three parallelogram linkages which form an anti-self-rotating mechanism. Each thrust-canceling shaft 20 comprises a left end 21A, a right end 21B, a sleeve 23, and a pre-loading screw 22. The length of the sleeve 23 should be set at such a value that the two ends 21A and 21B contact the sleeve 23 with proper pre-load. The pulley 31 of a generator 30 is driven by the three pulleys 18 through a belt 33. A pre-tensioning pulley 32 is used to increase the wrap angles on the three pulleys 18 and the pulley 31 of the generator 30 and to apply proper pre-tension to the belt 33. The orbiting scrolls 3A and 3B provide more even driving force to the three rotating members 10, and this makes the operation of the machine smoother and more reliable. When the orbiting scrolls 3A and 3B orbit, the volumes formed by the spiral wraps 9A, 9B and 6A, 6B of the stationary scrolls 2A and 2B and the orbiting scrolls 3A and 3B are continuously changed, fluid introduced through suction ports 5A and 5B is continuously expanded, and finally the expanded fluid is discharged through the discharge ports 4A and 4B. During the process, the fluid generates thrusting force exerted on the end plates 8A and 8B of the orbiting scrolls 3A and 3B. Most of the thrusting force is canceled through the three thrust-canceling shafts 20, and the rest is withstood by the bearings 11A, 11B, 14A, and 14B in the orbiting units 40. The frictional consumption of power is reduced because of the cancellation of the axial thrusting force, and this gives this machine high efficiency.

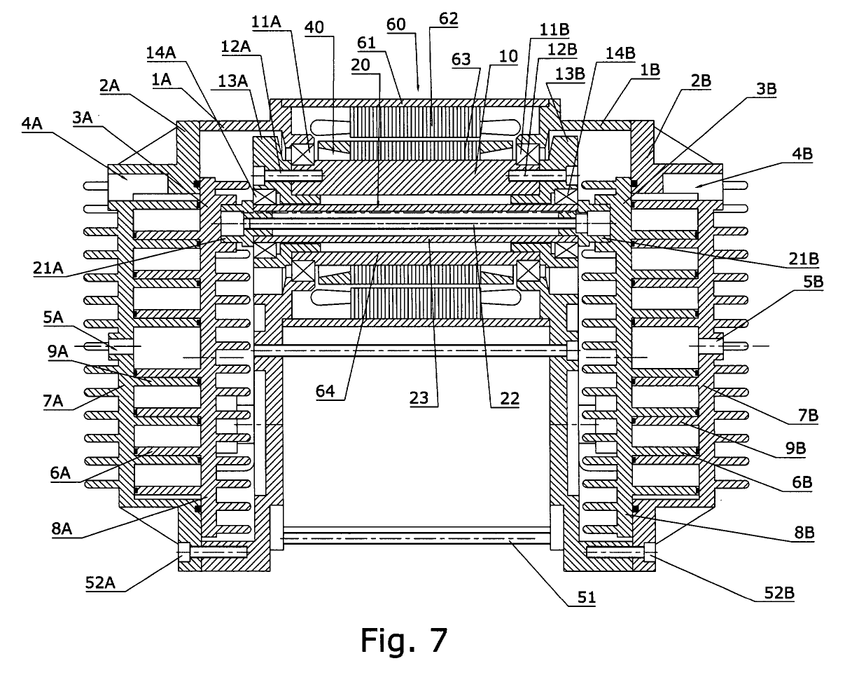

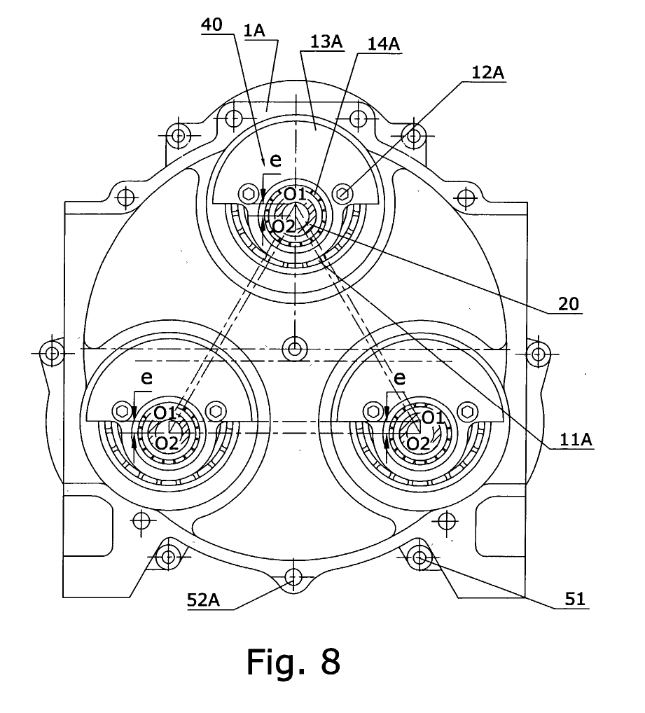

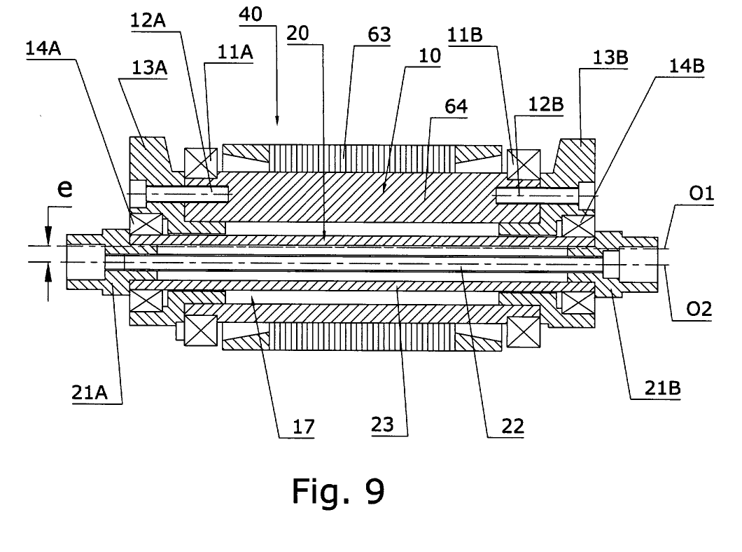

FIG. 7 is a schematic sectional view of a scroll compressor according to the third embodiment of the present invention. FIG. 8 is the left view of the compressor excluding its left stationary scroll and left orbiting scroll. FIG. 9 is a schematic sectional view of its orbiting unit. As shown in FIGS. 7-9, shells 61 of three motors 60 are fixed between two housings 1A and 1B, with stators 62 of the motors 60 fixed in the shells 61. The left housing 1A and the right housing 1B are mounted in a mirror-image relationship through screws 51. A left stationary scroll 2A is connected to the left housing 1A through screws 52A, and a right stationary scroll 2B is connected to the right housing 1B through screws 52B. The two housings 1A and 1B, the two stationary scrolls 2A and 2B, and the shells 61 with the stators 62 compose the fixed structure of this machine. The two stationary scrolls 2A and 2B comprise, respectively, their own end plates 7A and 7B and spiral wraps 9A and 9B standing on the corresponding end plates 7A and 7B. Two suction ports 4A and 4B should be connected, and two discharge ports 5A and 5B should be connected. The two orbiting scrolls 3A and 3B comprise, respectively, their own end plates 8A and 8B and spiral wraps 6A and 6B standing on the corresponding end plates 8A and 8B. Furthermore, the directions of the spiral wraps 6A and 6B should be arranged in a mirror-image relationship, and the directions of the spiral wraps 9A and 9B should be arranged in a mirror-image relationship. Three orbiting units 40 are mounted between the two orbiting scrolls 3A and 3B. Each of the three orbiting units 40 comprises a rotating member 10 rotatably supported on the two housings 1A and 1B through two bearings 11A and 11B, and a thrust-canceling shaft 20 rotatably supported in the rotating member 10 by two bearings 14A and 14B. The rotating member 10 comprises a hollow shaft 64 with an eccentric through-hole 17, a motor rotor 63 fixed on the hollow shaft 64, and two balancing weights 13 A and 13B fitted in the eccentric through-hole 17 through screws 12A and 12B. The bearings 14A and 14B are fitted in the balancing weights 13 A and 13B, respectively, to support the thrust-canceling shaft 20. The rotating axis O2 of the thrust-canceling shaft 20 is eccentric from the rotating axis O1 of the hollow shaft 64 with a distance of e. The three thrust-canceling shafts 20 are fixed between the two orbiting scrolls 3A and 3B. As shown in FIG. 8, the triangle formed by O1-O1-O1 is identical to the triangle formed by O2-O2-O2. The three orbiting units 40, the two orbiting scroll 3A and 3B, and the two housings 1A and 1B compose three parallelogram linkages which form an anti-self-rotating mechanism. Each thrust-canceling shaft 20 comprises a left end 21A, a right end 21B, a sleeve 23, and a pre-loading screw 22. The length of the sleeve 23 should be set at such a value that the two ends 21A and 21B contact the sleeve 23 with proper pre-load. The orbiting scrolls 3A and 3B get much more even driving force from the three motors 60, and this makes the operation of the machine smoother and more reliable. When the orbiting scrolls 3A and 3B orbit, the volumes formed by the spiral wraps 9A, 9B and 6A, 6B of the stationary scrolls 2A and 2B and the orbiting scrolls 3A and 3B are continuously changed, fluid introduced through suction ports 4A and 4B is continuously compressed, and finally the compressed fluid is discharged through the discharge ports 5A and 5B. During the process of compression, the fluid generates thrusting force exerted on the end plates 8A and 8B of the orbiting scrolls 3A and 3B. Most of the thrusting force is canceled through the three thrust-canceling shafts 20, and the rest is withstood by the bearings 11A, 11B, 14A, and 14B in the orbiting units 40. The frictional consumption of power is reduced because of the cancellation of the axial thrusting force, and this gives this machine high efficiency.

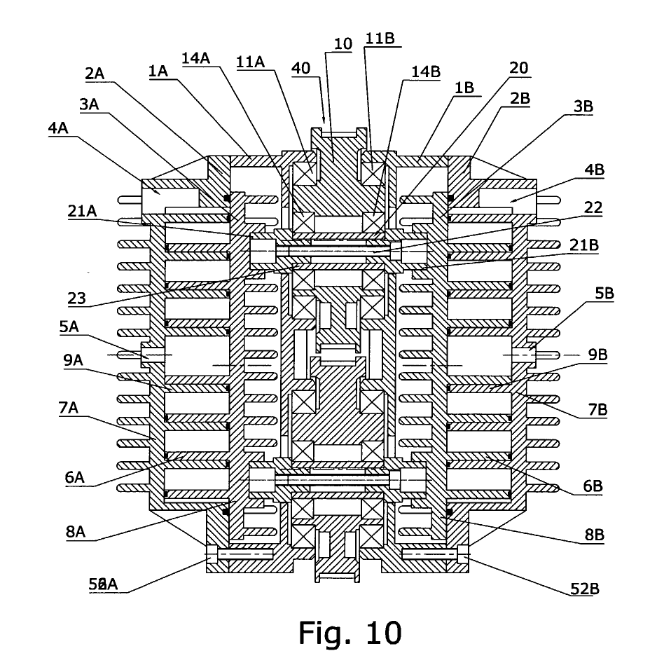

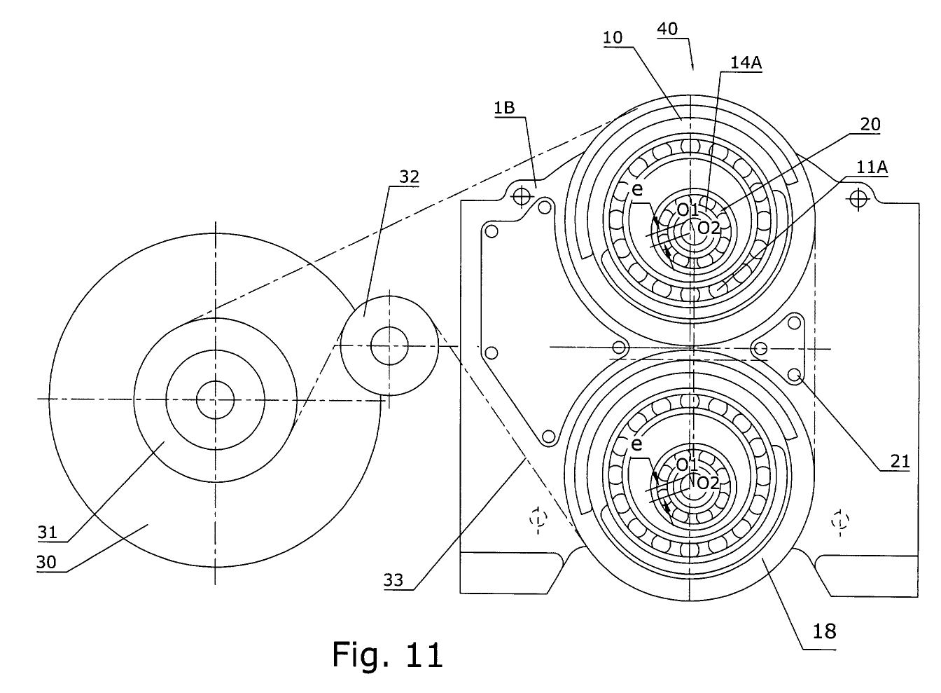

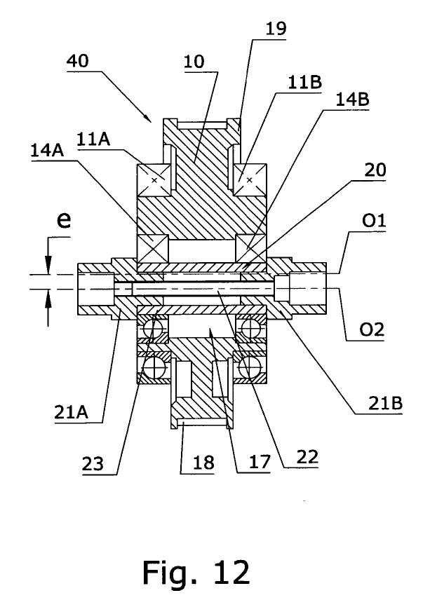

FIG. 10 is a schematic sectional view of a scroll compressor according to the forth embodiment of the present invention. FIG. 11 is the left view of the compressor excluding its left stationary scroll, left orbiting scroll, and left housing. FIG. 12 is a schematic sectional view of its orbiting unit. As shown in FIGS. 10-12, a left housing 1A and a right housing 1B are mounted in a mirror-image relationship through screws 51. A left stationary scroll 2A is connected to the left housing 1A through screws 52A, and a right stationary scroll 2B is connected to the right housing 1B through screws 52B. The two housings 1A and 1B and the two stationary scrolls 2A and 2B compose the fixed structure of this machine. The two stationary scrolls 2A and 2B comprise, respectively, their own end plates 7A and 7B and spiral wraps 9A and 9B standing on the corresponding end plates 7A and 7B. Two suction ports 4A and 4B should be connected, and two discharge ports 5A and 5B should be connected. The two orbiting scrolls 3A and 3B comprise, respectively, their own end plates 8A and 8B and spiral wraps 6A and 6B standing on the corresponding end plates 8A and 8B. Furthermore, the directions of the spiral wraps 6A and 6B should be arranged in a mirror-image relationship, and the directions of the spiral wraps 9A and 9B should be arranged in a mirror-image relationship. Two orbiting units 40 are mounted between the two orbiting scrolls 3A and 3B. Each of the two orbiting units 40 comprises a rotating member 10 rotatably supported on the two housings 1A and 1B through two bearings 11A and 11B, and a thrust-canceling shaft 20 rotatably supported in the rotating member 10 by two bearings 14A and 14B. The rotating member 10 comprises a balancing weight 19, a synchronous pulley 18 located on the periphery of the rotating member 10, and an eccentric through-hole 17. The two thrust-canceling shafts 20 are fixed between the two orbiting scrolls 3A and 3B. Each thrust-canceling shaft 20 comprises a left end 21A, a right end 21B, a sleeve 23, and a pre-loading screw 22. The length of the sleeve 23 should be set at such a value that the two ends 21A and 21B contact the sleeve 23 with proper pre-load. The synchronous pulleys 18 are driven by the synchronous pulley 31 of a motor 30. A pre-tensioning pulley 32 is used to increase the wrap angle on the two synchronous pulleys 18 and the pulley 31 of the motor 30 and to apply proper pre-tension to the synchronous belt 33. The rotating axis O2 of the thrust-canceling shaft 20 is eccentric from the rotating axis O1 of the rotating member 10 with a distance of e. As shown in FIG. 11, O1-O2-O2-O1 forms a parallelogram linkage. The two orbiting units plus the synchronous belt 33 form an anti-self-rotating mechanism. The orbiting scrolls 3A and 3B can get more even driving force from the two orbiting units, and this makes the machine smoother and more reliable. The volumes formed by the spiral wraps 9A, 9B and 6A, 6B of the stationary scrolls 2A and 2B and the orbiting scrolls 3A and 3B change continuously when the orbiting scrolls 3A and 3B orbit. Fluid introduced through suction ports 4A and 4B is continuously compressed, and discharged through discharge ports 5A and 5B. During the process of compression, the fluid generates thrusting force exerted on the end plates 8A and 8B of orbiting scrolls 3A and 3B. Most of the thrusting force is canceled through the two thrust-canceling shafts 20, and the rest is withstood by the bearings 11A, 11B, 14A, and 14B in the orbiting units 40. The frictional consumption of power is reduced because of the cancellation of the axial thrusting force, and this gives this machine a high efficiency.

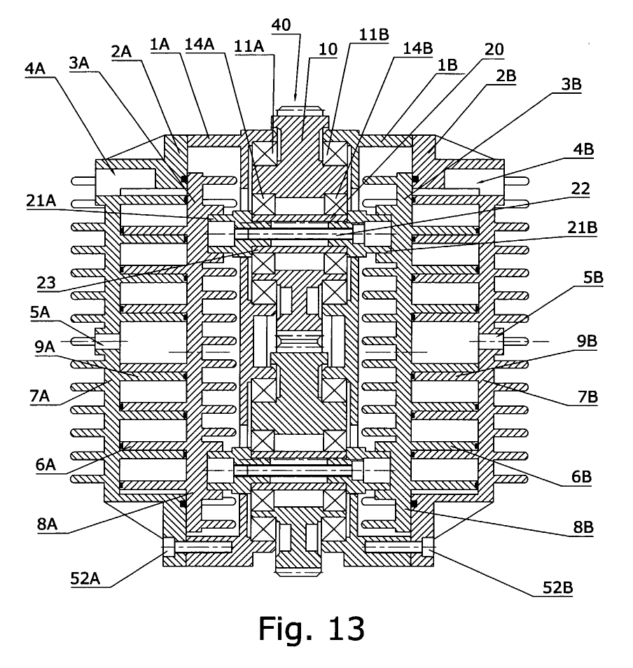

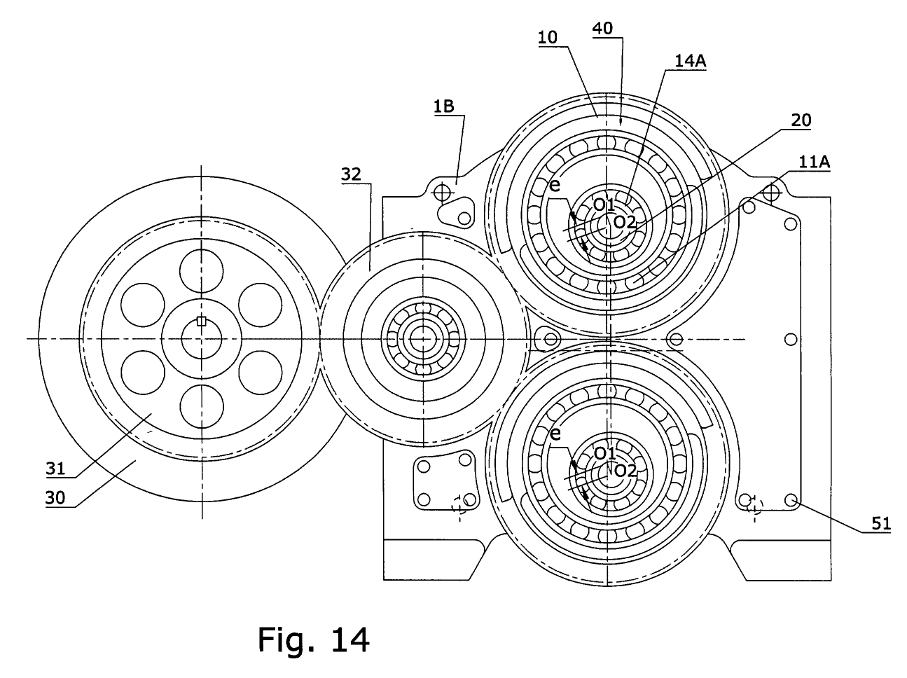

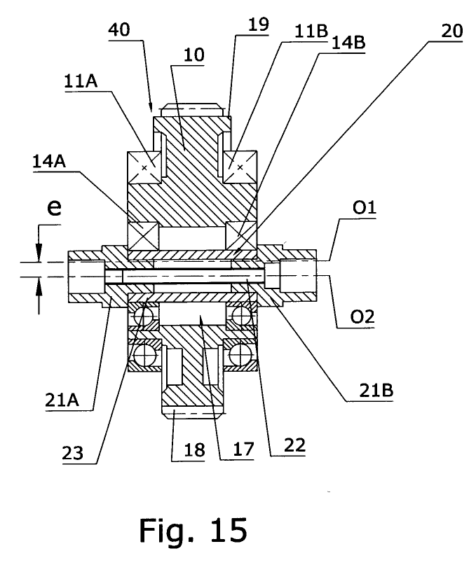

FIG. 13 is a schematic sectional view of a scroll compressor according to the fourth embodiment of the present invention. FIG. 14 is the left view of the compressor excluding its left stationary scroll, left orbiting scroll, and left housing. FIG. 15 is a schematic sectional view of its orbiting unit. As shown in FIGS. 13-15, a left housing 1A and a right housing 1B are mounted in a mirror-image relationship through screws 51. A left stationary scroll 2A is connected to the left housing 1A through screws 52A, and a right stationary scroll 2B is connected to the right housing 1B through screws 52B. The two housings 1A and 1B and the two stationary scrolls 2A and 2B compose the fixed structure of this machine. The two stationary scrolls 2A and 2B comprise, respectively, their own end plates 7A and 7B and spiral wraps 9A and 9B standing on the corresponding end plates 7A and 7B. Two suction ports 4A and 4B should be connected, and two discharge ports 5A and 5B should be connected. The two orbiting scrolls 3A and 3B comprise, respectively, their own end plates 8A and 8B and spiral wraps 6A and 6B standing on the corresponding end plates 8A and 8B. Furthermore, the directions of the spiral wraps 6A and 6B should be arranged in a mirror-image relationship, and the directions of the spiral wraps 9A and 9B should be arranged in a mirror-image relationship. Two orbiting units 40 are mounted between the two orbiting scrolls 3A and 3B. Each of the two orbiting units 40 comprises a rotating member 10 rotatably supported on the two housings 1A and 1B through two bearings 11A and 11B, and a thrust-canceling shaft 20 rotatably supported in the rotating member 10 by two bearings 14A and 14B. The rotating member 10 comprises a balancing weight 19, a gear 18 located on the periphery of the rotating member 10, and an eccentric through-hole 17. The two thrust-canceling shafts 20 are fixed between the two orbiting scrolls 3A and 3B. Each thrust-canceling shaft 20 comprises a left end 21A, a right end 21B, a sleeve 23, and a pre-loading screw 22. The length of the sleeve 23 should be set at such a value that the two ends 21A and 21B contact the sleeve 23 with proper pre-load. The two gears 18 are driven by the gear 31 of a motor 30 through an idler gear 32. The rotating axis O2 of the thrust-canceling shaft 20 is eccentric from the rotating axis O1 of the rotating member 10 with a distance of e. As shown in FIG. 14, O1-O2-O2-O1 forms a parallelogram linkage. The two orbiting units plus the idler gear 32 form an anti-self-rotating mechanism. The orbiting scrolls 3A and 3B can get more even driving force from the two orbiting units, and this makes the machine smoother and more reliable. The volumes formed by the spiral wraps 9A, 9B and 6A, 6B of the stationary scrolls 2A and 2B and the orbiting scrolls 3A and 3B change continuously when the orbiting scrolls 3A and 3B orbit. Fluid introduced through suction ports 4A and 4B is continuously compressed, and discharged through discharge ports 5A and 5B. During the process of compression, the fluid generates thrusting force exerted on the end plates 8A and 8B of orbiting scrolls 3A and 3B. Most of the thrusting force is canceled through the two thrust-canceling shafts 20, and the rest is withstood by the bearings 11A, 11B, 14A, and 14B in the orbiting units 40. The frictional consumption of power is reduced because of the cancellation of the axial thrusting force, and this gives this machine a high efficiency.

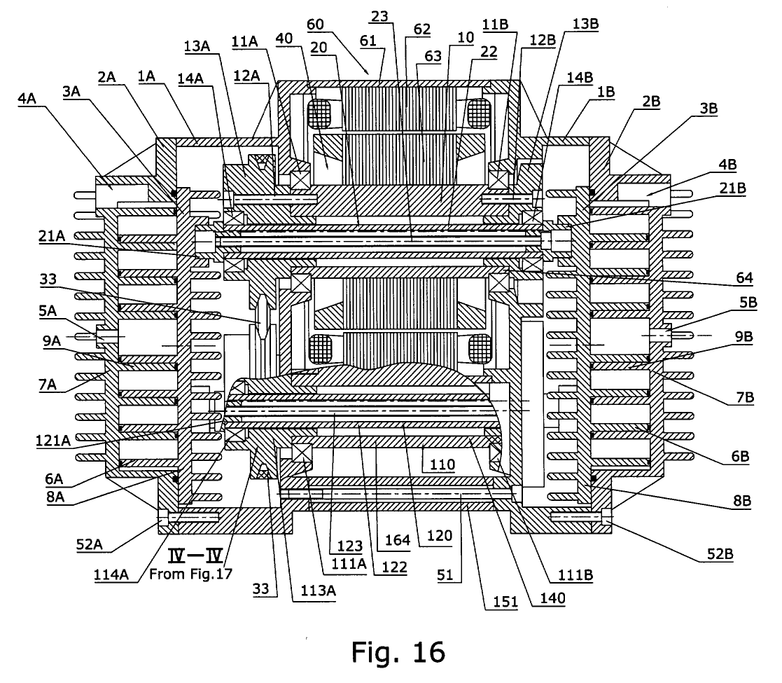

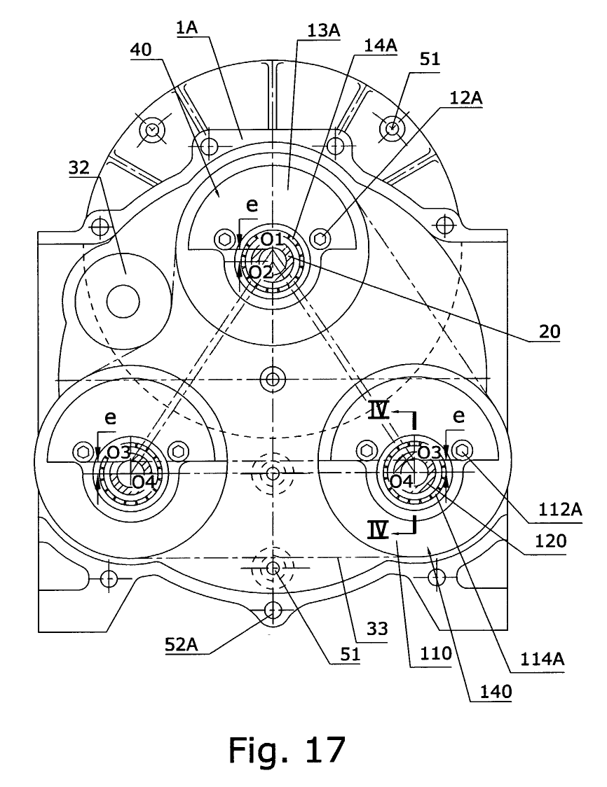

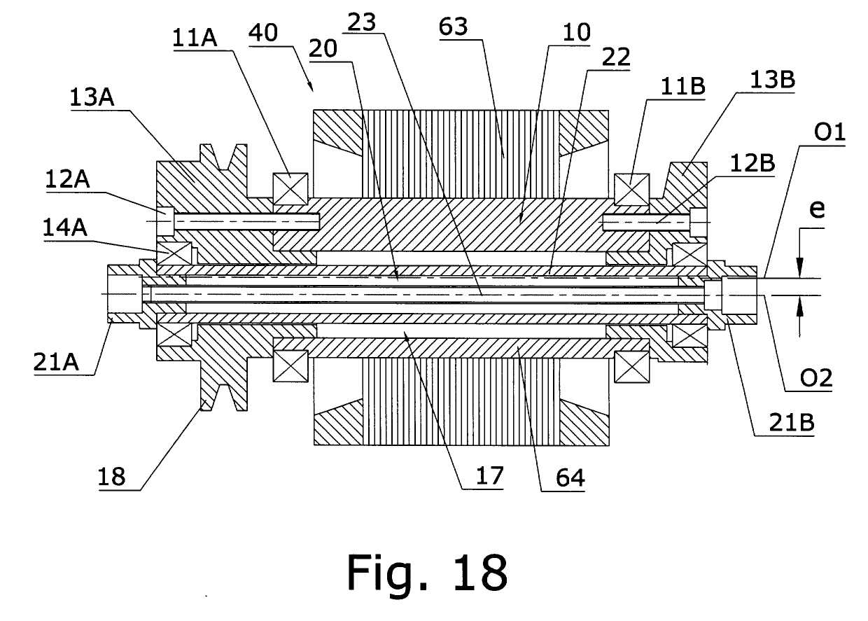

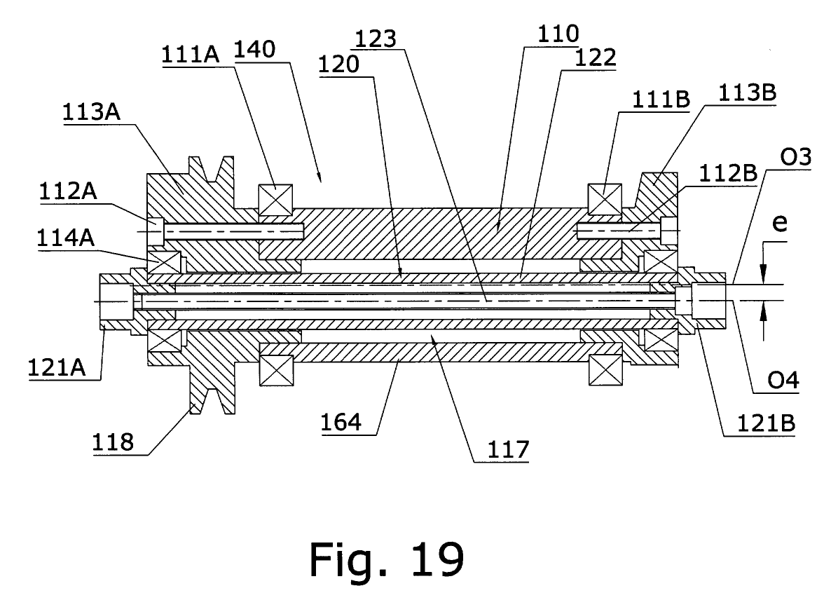

FIG. 16 is a schematic sectional view of a scroll compressor according to the sixth embodiment of the present invention. FIG. 17 is its left view excluding the left stationary scroll and left orbiting scroll. FIG. 18 is a schematic sectional view of its orbiting unit 40. FIG. 19 is a schematic sectional view of its orbiting unit 140. As shown in FIGS. 16-19, the shell 61 of a motor 60 and two mounting sleeves 151 are mounted between two housings 11A and 1B. A stator 62 is fixed in the shell 61. The left housing 1A and the right housing 1B are fixed through screws 51. The left housing 1A is connected to the left stationary scroll 2A through screw set 52A, and the right housing 1B is connected to the right stationary scroll 2B through screw set 52B. The two housings 1A and 1B, the two stationary scrolls 2A and 2B, the shell 61 with the stator 62, and the two mounting sleeves 151 compose the fixed structure of this machine. The two stationary scrolls 2A and 2B comprise, respectively, their own end plates 7A and 7B and spiral wraps 9A and 9B standing on the corresponding end plates 7A and 7B. Two suction ports 4A and 4B should be connected, and two discharge ports 5A and 5B should be connected. The two orbiting scrolls 3A and 3B comprise, respectively, their own end plates 8A and 8B and spiral wraps 6A and 6B standing on the corresponding end plates 8A and 8B. Furthermore, the directions of the spiral wraps 6A and 6B should be arranged in a mirror-image relationship, and the directions of the spiral wraps 9A and 9B should be arranged in a mirror-image relationship. One orbiting unit 40 and two orbiting units 140 are mounted between the two orbiting scrolls 3A and 3B. The orbiting unit 40, as shown in FIG. 18, comprises a rotating member 10 rotatably supported on the two housings 1A and 1B through two bearings 11A and 11B, and a thrust-canceling shaft 20 rotatably supported in the rotating member 10 by two bearings 14A and 14B. The rotating member 10 comprises a hollow shaft 64 with an eccentric through-hole 17, a motor rotor 63 fixed on the hollow shaft 64, a left balancing weight 13A with a pulley 18 fitted in the eccentric through-hole 17 through screws 12A, a right balancing weight 13B fitted in the eccentric through-hole 17 through screws 12B. The bearing 14A fitted in the left balancing weight 13A and the bearing 14B fitted in the right balancing weight 13B support the thrust-canceling shaft 20.The rotating axis O2 of the thrust-canceling shaft 20 has an eccentric distance e from the rotating axis O1 of the rotating member 10. The thrust-canceling shaft 20 comprises the left end 21A, the right end 21B, sleeve 23, and the pre-loading screw 22. The length of the sleeve 23 should make the two end 21A and 21B contact sleeve 23 with proper pre-load. Each of the two orbiting units 140, as shown in FIG. 19, comprises a rotating member 110 rotatably supported on the two housings 1A and 1B through two bearings 111A and 111B, and a thrust-canceling shaft 120 rotatably supported in the rotating member 110 by two bearings114A and 114B. The rotating member 110 comprises a hollow shaft 164 with an eccentric through-hole 17, a left balancing weight 113A with a pulley 118 fitted in the eccentric through-hole 117 through screws 112A, a right balancing weight 113B fitted in the eccentric through-hole 117 through screws 112B. The bearing 114A fitted in the left balancing weight 113A and the bearing 114B fitted in the right balancing weight 113B support the thrust-canceling shaft 120. The rotating axis O4 of the thrust-canceling shaft 120 has an eccentric distance e from the rotating axis O3 of the rotating member 110. Each thrust-canceling shaft 120 comprises the left end 121A, the right end 121B, sleeve 123, and the pre-loading screw 122. The length of the sleeve 123 should make the two end 121A and 121B contact sleeve 123 with proper pre-load. As shown in FIG. 17, the triangle formed by O1-O3-O3 is identical to the triangle formed by O2-O4-O4 , One orbiting unit 40 and two orbiting units 140, two orbiting scroll 3A and 3B, and the two housings 1A and 1B compose three parallelogram linkages which form an anti-self-rotating mechanism. The volumes formed by the spiral wraps 9A, 9B and 6A, 6B of the stationary scrolls 2A and 2B and the orbiting scrolls 3A and 3B change continuously when the orbiting scrolls 3A and 3B orbit. Fluid introduced through suction ports 4A and 4B is continuously compressed, and discharged through discharge ports 5A and 5B. During the process of compression, the fluid generates thrusting force exerted on the end plates 8A and 8B of orbiting scrolls 3A and 3B. Most of the thrusting force is canceled through thrust-canceling shaft 20 of the orbiting unit 40 and thrust-canceling shafts 120 of the two orbiting units 140, and the rest is withstood by the bearings 11A, 11B, 14A, and 14B in the orbiting unit 40 and the bearings 111A, 111B, 114A, and 114B in the orbiting units 140. The frictional consumption of power is reduced because of the cancellation of the axial thrusting force, and this gives this machine a high efficiency.

In the embodiments described hereinbefore, all of orbiting units are to transmit driving force in one aspect, and to form parallelogram linkage mechanisms in another aspect. Not all orbiting units are necessarily involved in the transmission of driving force, and it is possible to use other methods to transmit driving force without any of the orbiting units involved.

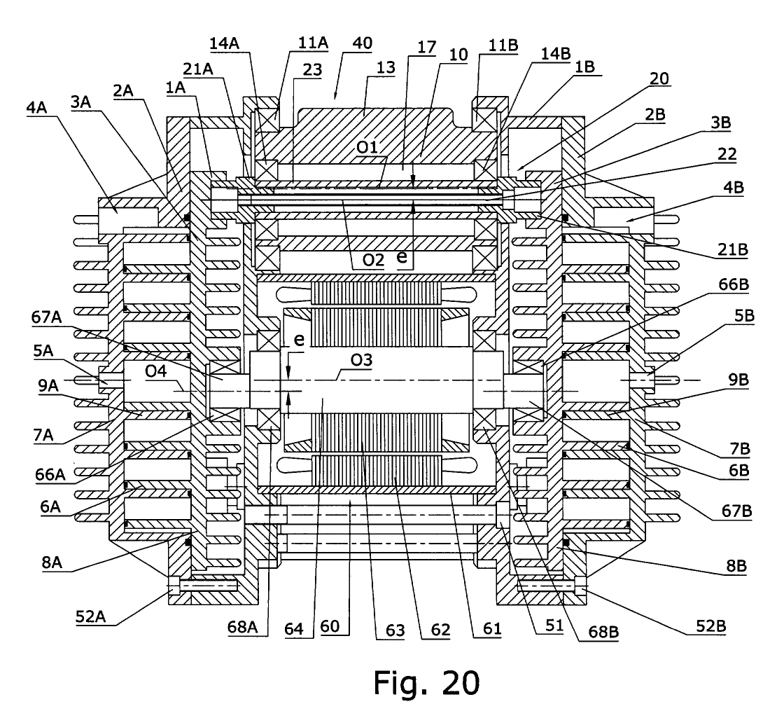

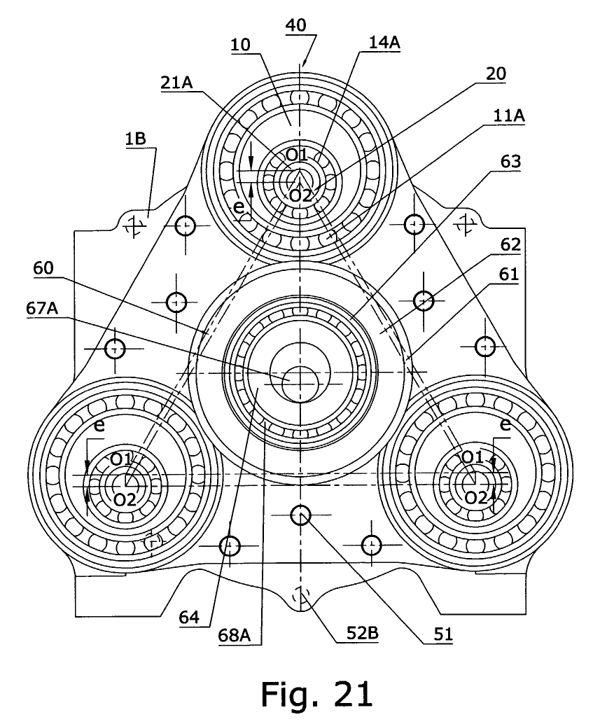

FIG. 20 is a schematic sectional view of a scroll compressor according to the seventh embodiment of the present invention. FIG. 21 is its left view excluding the left stationary scroll, left orbiting scroll, and left housing. As shown in FIGS. 20 and 21, the shell 61 of a motor 60 is mounted between two housings 1A and 1B. A stator 62 is fixed in the shell 61. The left housing 1A and the right housing 1B are fixed through screws 51. The left housing 1A is connected to the left stationary scroll 2A through screw set 52A, and the right housing 1B is connected to the right stationary scroll 2B through screw set 52B. The two housings 1A and 1B, the two stationary scrolls 2A and 2B, the shell 61 with the stator 62 compose the fixed structure of this machine. The two stationary scrolls 2A and 2B comprise, respectively, their own end plates 7A and 7B and spiral wraps 9A and 9B standing on the corresponding end plates 7A and 7B. Two suction ports 4A and 4B should be connected, and two discharge ports 5A and 5B should be connected. The two orbiting scrolls 3A and 3B comprise, respectively, their own end plates 8A and 8B and spiral wraps 6A and 6B standing on the corresponding end plates 8A and 8B. Furthermore, the directions of the spiral wraps 6A and 6B should be arranged in a mirror-image relationship, and the directions of the spiral wraps 9A and 9B should be arranged in a mirror-image relationship. Three orbiting units 40 are mounted between the two orbiting scrolls 3A and 3B. Each of the three orbiting unit 40 comprises a rotating member 10 rotatably supported on the two housings 1A and 1B through two bearings 11A and 11B, and a thrust-canceling shaft 20 rotatably supported in the eccentric through-hole 17 of rotating member 10 by two bearings 14A and 14B. The rotating member 10 is formed together with a balancing weight 13. The rotating axis O2 of the thrust-canceling shaft 20 has an eccentric distance e from the rotating axis O1 of the rotating member 10. The thrust-canceling shaft 20 comprises the left end 21A, the right end 21B, sleeve 23, and the pre-loading screw 22. The length of the sleeve 23 should make the two end 21A and 21B contact sleeve 23 with proper pre-load. As shown in FIG. 21, the triangle formed by O1-O1-O1 is identical to the triangle formed by O2-O2-O2. The three orbiting units 40, the two orbiting scroll 3A and 3B, and the two housings 1A and 1B compose three parallelogram linkages that form an anti-self-rotating mechanism. The crankshaft 64 of the motor 60 is rotatably supported on the two housings 1A and 1B through two bearings 68A and 68B. Left crank portion 67A formed at one end of crankshaft 64 for rotatably supporting the left orbiting scroll 3A though a bearing 66A, and a right crank portion 67B formed at the other end of crankshaft 64 for rotatably supporting right orbiting scroll 3B. The rotor 63 of the motor 60 fitted on the crankshaft 64. The rotating axis O4 of the two crank portions 67A and 67B has an eccentric distance e from the rotating axis O3 the crankshaft 64. The volumes formed by the spiral wraps 9A, 9B and 6A, 6B of the stationary scrolls 2A and 2B and the orbiting scrolls 3A and 3B change continuously when the orbiting scrolls 3A and 3B orbit. Fluid introduced through suction ports 4A and 4B is continuously compressed, and discharged through discharge ports 5A and 5B. During the process of compression, the fluid generates thrusting force exerted on the end plates 8A and 8B of orbiting scrolls 3A and 3B. Most of the thrusting force is canceled through three thrust-canceling shafts 20,and the rest is withstood by the bearings 11A, 11B, 14A, and 14B in the orbiting units 40.The frictional consumption of power is reduced because of the cancellation of the axial thrusting force, and this gives this machine a high efficiency.

In the embodiments described hereinbefore, the eccentric distances e of all the orbiting units or the crankshaft in an embodiment are substantially equal, and can be represented by:

$$e = \frac{p}{2} - t ,$$

where p corresponds to the pitch of the scroll wraps and t is the wall thickness of each wrap.

Although in the foregoing embodiments, the present invention has been described taking scroll compressor and scroll expander as examples of scroll type of fluid machineries, the present invention is not necessarily limited to the scroll compressor and scroll expander, but may also be widely applied to other scroll type of fluid machineries, such as vacuum pumps, refrigerant compressors, etc.

Although in the foregoing embodiments, the scroll type of fluid machinery comprises two fluid volume changing mechanisms arranged in a mirror-image relationship, the present invention is not necessarily limited to the described arrangement. For example, the two fluid volume changing mechanisms can be different from each other in dimension.

Although in the foregoing embodiments, the scroll type of fluid machinery comprises two fluid volume changing mechanisms having the same function, the present invention is not necessarily limited to the described usages. For example, one of the two fluid volume changing mechanisms can be used as a compression mechanism while the other used as an expansion mechanism.

Although in the foregoing embodiments, the two suction ports are arranged to be connected and the two discharge ports are also arranged to be connected, it should be noted that the present invention is not necessarily limited to the described arrangement. For example, the discharge port of the first fluid volume changing mechanism is connected to the suction port of the second fluid volume changing mechanism.

Although in the foregoing embodiments, two or three orbiting units are arranged in a machine, the present invention is not necessarily limited to the number of the orbiting units. Four or more orbiting units can be arranged in a machine.

What I claim as my invention is:

1. A scroll type of fluid machinery comprising:
a first housing and a second housing fixedly provided to said first housing;
a first fluid volume changing mechanism comprising a first stationary scroll having a first scroll wrap, and a first orbiting scroll having on one surface thereof a second scroll wrap, said first orbiting scroll being assembled with said first stationary scroll such that, when said second scroll wrap orbits with respect to said first scroll wrap, fluid introduced therebetween is changed in volume and discharged;
said first stationary scroll fixedly provided to said first housing;
a second fluid volume changing mechanism comprising a second stationary scroll having a third scroll wrap, and a second orbiting scroll having on one surface thereof a fourth scroll wrap, said second orbiting scroll being assembled with said second stationary scroll such that, when said fourth scroll wrap orbits with respect to said third scroll wrap, fluid introduced therebetween is changed in volume and discharged;
said second stationary scroll fixedly provided to said second housing;
two orbiting units provided between said first fluid volume changing mechanism and said second fluid volume changing mechanism, each of said two orbiting units comprising a rotating member and a thrust-canceling shaft, said rotating member having an eccentric through-hole and being rotatably supported by said first and said second housing, said thrust-canceling shaft fixedly provided with one end thereof to said first orbiting scroll and with the other end thereof to said second orbiting scroll, said thrust-canceling shaft further being rotatably supported in said eccentric through-hole of said rotating member, said two orbiting units being arranged as a parallelogram linkage for preventing self-rotation of said first and second orbiting scrolls.

2. A scroll type of fluid machinery comprising:
a first housing and a second housing fixedly provided to said first housing;
a first fluid volume changing mechanism comprising a first stationary scroll having a first scroll wrap, and a first orbiting scroll having on one surface thereof a second scroll wrap, said first orbiting scroll being assembled with said first stationary scroll such that, when said second scroll wrap orbits with respect to said first scroll wrap, fluid introduced therebetween is changed in volume and discharged;
said first stationary scroll fixedly provided to said first housing;
a second fluid volume changing mechanism comprising a second stationary scroll having a third scroll wrap, and a second orbiting scroll having on one surface thereof a fourth scroll wrap, said second orbiting scroll being assembled with said second stationary scroll such that, when said fourth scroll wrap orbits with respect to said third scroll wrap, fluid introduced therebetween is changed in volume and discharged;
said second stationary scroll fixedly provided to said second housing;
three orbiting units provided between said first fluid volume changing mechanism and said second fluid volume changing mechanism, each of said three orbiting units comprising a rotating member and a thrust-canceling shaft, said rotating member having an eccentric through-hole and being rotatably supported by said first housing and said second housing, said thrust-canceling shaft fixedly provided with one end thereof to said first orbiting scroll and with the other end thereof to said second orbiting scroll, said thrust-canceling shaft further being rotatably supported in said eccentric through-hole of said rotating member;
an anti-self-rotating mechanism formed by said three orbiting units for said first and second orbiting scrolls.

3. A scroll type of fluid machinery comprising:
a first housing and a second housing fixedly provided to said first housing;
a first fluid volume changing mechanism comprising a first stationary scroll having a first scroll wrap, and a first orbiting scroll having on one surface thereof a second scroll wrap, said first orbiting scroll being assembled with said first stationary scroll such that, when said second scroll wrap orbits with respect to said first scroll wrap, fluid introduced therebetween is changed in volume and discharged;
said first stationary scroll fixedly provided to said first housing;
a second fluid volume changing mechanism comprising a second stationary scroll having a third scroll wrap, and a second orbiting scroll having on one surface thereof a fourth scroll wrap, said second orbiting scroll being assembled with said second stationary scroll such that, when said fourth scroll wrap orbits with respect to said third scroll wrap, fluid introduced therebetween is changed in volume and discharged;
said second stationary scroll fixedly provided to said second housing;
four or more orbiting units provided between said first fluid volume changing mechanism and said second fluid volume changing mechanism, each of said four or more orbiting units comprising a rotating member and a thrust-canceling shaft, said rotating member having an eccentric through-hole and being rotatably supported by said first housing and said second housing, said thrust-canceling shaft fixedly provided with one end thereof to said first orbiting scroll and with the other end thereof to said second orbiting scroll, said thrust-canceling shaft further being rotatably supported in said eccentric through-hole of said rotating member;
an anti-self-rotating mechanism formed by said four or more orbiting units for said first and second orbiting scrolls.

4. The scroll type of fluid machinery according to claim 1, wherein the outer peripheries of said rotating members of said two orbiting units are synchronous pulleys drivingly connected in synchronization with each other by a synchronous belt.

5. The scroll type of fluid machinery according to claim 1, wherein the outer peripheries of said rotating members of said two orbiting units are two gears engaged with a third gear in synchronization with each other.

6. The scroll type of fluid machinery according to claim 1, wherein each of said rotating members of said orbiting units further comprising a rotor fixed on a shaft of a motor, said shaft of said motor having said eccentric through-hole, said motor having a stator fixedly provided between said first housing and said second housing.

7. The scroll type of fluid machinery according to claim 1, wherein
a first rotating member of said two rotating members comprising a rotor fixed on a first hollow shaft of a motor, a first synchronous pulley fixed on said first hollow shaft of said motor, and a first said eccentric through-hole being in said first hollow shaft of said motor, said motor having a stator fixedly provided between said first housing and said second housing;
a second rotating member of said two rotating members comprising a second hollow shaft having a second said eccentric through-hole, and a second synchronous pulley fixed on said second hollow shaft;
a synchronous belt drivingly connecting with said first and second synchronous pulleys to synchronize said first and second synchronous pulleys.

8. The scroll type of fluid machinery according to claim 1, wherein
a first rotating member of said two rotating members comprising a rotor fixed on a first hollow shaft of a motor, a first gear fixed on said first hollow shaft of said motor, and a first said eccentric through-hole being in said first hollow shaft of said motor, said motor having a stator fixedly provided between said first housing and said second housing;
a second rotating member of said two rotating members comprising a second hollow shaft having a second said eccentric through-hole, and a second gear fixed on said second hollow shaft;
a third gear engaging with said first gear and said second gear to synchronize said first and second gears.

9. The scroll type of fluid machinery according to claim 2, wherein the outer peripheries of said rotating members of said three orbiting units are three pulleys, said three pulleys being drivingly connected by a belt.

10. The scroll type of fluid machinery according to claim 2, wherein each said rotating member of said orbiting units further comprising a rotor fixed on a hollow shaft of a motor, and a said eccentric through-hole being in said hollow shaft of said motor, said motor having a stator fixedly provided between said first housing and said second housing;

11. The scroll type of fluid machinery according to claim 2, wherein
a first rotating member of three said rotating members comprising a rotor fixed on a first hollow shaft of a motor, a first pulley fixed on said first hollow shaft of said motor, and a first said eccentric through-hole being in said first hollow shaft of said motor, said motor having a stator fixedly provided between said first housing and said second housing;
a second rotating member of three said rotating members comprising a second hollow shaft having a second said eccentric through-hole, and a second pulley fixed on said second hollow shaft;
a third rotating member of three said rotating members comprising a third hollow shaft having a third said eccentric through-hole, and a third pulley fixed on said third hollow shaft
a belt drivingly connecting with said first, second, and third pulleys.

12. The scroll type of fluid machinery according to claim 1, wherein a crank mechanism provided between said first and said second fluid volume changing mechanisms, said crank mechanism comprising a crankshaft rotatably supported between said first and said second housings, a first crank portion formed at one end of said crankshaft for rotatably supporting said first orbiting scroll, and a second crank portion formed at the other end of said crankshaft for rotatably supporting said second orbiting scroll.

13. The scroll type of fluid machinery according to claim 2, wherein a crank mechanism provided between said first and said second fluid volume changing mechanisms, said crank mechanism comprising a crankshaft rotatably supported between said first and said second housing, a first crank portion formed at one end of said crankshaft for rotatably supporting said first orbiting scroll, and a second crank portion formed at the other end of said crankshaft for rotatably supporting said second orbiting scroll.

14. The scroll type of fluid machinery according to claim 1, wherein a motor provided between said first and said second fluid volume changing mechanisms, said motor comprising a stator fixedly provided between said first and said second housings, a rotor fixed on a motor shaft, said motor shaft rotatably supported between said first and said second housings, a first crank portion formed at one end of said motor shaft for rotatably supporting said first orbiting scroll, and a second crank portion formed at the other end of said motor shaft for rotatably supporting said second orbiting scroll.

15. The scroll type of fluid machinery according to claim 2, wherein a motor provided between said first and said second fluid volume changing mechanisms, said motor comprising a stator fixedly provided between said first and said second housings, a rotor fixed on a motor shaft, said motor shaft rotatably supported between said first and said second housings, a first crank portion formed at one end of said motor shaft for rotatably supporting said first orbiting scroll, and a second crank portion formed at the other end of said motor shaft for rotatably supporting said second orbiting scroll.

16. The scroll type of fluid machinery according to claim 3, wherein a motor provided between said first and said second fluid volume changing mechanisms, said motor comprising a stator fixedly provided between said first and said second housings, a rotor fixed on a motor shaft, said motor shaft rotatably supported between said first and said second housings, a first crank portion formed at one end of said motor shaft for rotatably supporting said first orbiting scroll, and a second crank portion formed at the other end of said motor shaft for rotatably supporting said second orbiting scroll.

17. The scroll type of fluid machinery according to claim 2, wherein one or more of said orbiting units being used to transmit driving force to or from said first and said second fluid volume changing mechanisms.

18. The scroll type of fluid machinery according to claim 3, wherein one or more of said orbiting units being used to transmit driving force to or from said first and said second fluid volume changing mechanisms.

19. The scroll type of fluid machinery according to claim 4, wherein a third synchronous pulley drivingly connected with two said synchronous pulleys by said synchronous belt to transmit driving force between said two orbiting units and said third synchronous pulley.

20. The scroll type of fluid machinery according to claim 5, wherein a forth gear engaged to said third gear to transmit driving force between said two orbiting units and said forth gear.

21. The scroll type of fluid machinery according to claim 9, wherein a forth pulley drivingly connected with three said pulleys by said belt to transmit driving force between said three orbiting units and said forth pulley.

22. The scroll type of fluid machinery according to claim 1, wherein said rotating member is formed together with a balancing weight.

23. The scroll type of fluid machinery according to claim 2, wherein said rotating member is formed together with a balancing weight.

24. The scroll type of fluid machinery according to claim 1, wherein said rotating member having two balancing weights assembled thereon, said two balancing weights fitted to said eccentric through-hole of said rotating member, two holes being made, respectively, in said two balancing weights with larger diameter than said eccentric through-hole, two bearings fitted in said two holes of said two balancing weights to rotatably support said thrust-canceling shaft.

25. The scroll type of fluid machinery according to claim 2, wherein said rotating member having two balancing weights assembled thereon, said two balancing weights fitted to said eccentric through-hole of said rotating member, two holes being made, respectively, in said two balancing weights with larger diameter than said eccentric through-hole, two bearings fitted in said two holes of said two balancing weights to rotatably support said thrust-canceling shaft.

26. The scroll type of fluid machinery according to claim 1, wherein said first and second fluid volume changing mechanisms are provided in a mirror-image relationship.

27. The scroll type of fluid machinery according to claim 2, wherein said first and second fluid volume changing mechanisms are provided in a mirror-image relationship.

28. The scroll type of fluid machinery according to claim 3, wherein said first and second fluid volume changing mechanisms are provided in a mirror-image relationship.

29. The scroll type of fluid machinery according to claim 1, wherein said thrust-canceling shaft further comprising a sleeve, a first end fixed to one end of said sleeve, and a second end fixed to the other end of said sleeve, said first and second ends tied with each other through a pre-loading screw to pre-load two bearings, said two bearings supporting said thrust-canceling shaft.

30. The scroll type of fluid machinery according to claim 2, wherein said thrust-canceling shaft further comprising a sleeve, a first end fixed to one end of said sleeve, and a second end fixed to the other end of said sleeve, said first and second ends tied with each other through a pre-loading screw to pre-load two bearings, said two bearings supporting said thrust-canceling shaft.

31. The scroll type of fluid machinery according to claim 3, wherein said thrust-canceling shaft further comprising a sleeve, a first end fixed to one end of said sleeve, and a second end fixed to the other end of said sleeve, said first and second ends tied with each other through a pre-loading screw to pre-load two bearings, said two bearings supporting said thrust-canceling shaft.

32. The scroll type of fluid machinery according to claim 29, wherein said sleeve is made to such a length that said first end and said second end contact with said sleeve with proper pre-load.

33. The scroll type of fluid machinery according to claim 30, wherein said sleeve is made to such a length that said first end and said second end contact with said sleeve with proper pre-load.

34. The scroll type of fluid machinery according to claim 31, wherein said sleeve is made to such a length that said first end and said second end contact with said sleeve with proper pre-load.
